(19) United States
(12) Patent Application Publication
(10) Pub. No.: US 2025/0307460 A1
(43) Pub. Date: Oct. 2, 2025

(54) Non-transitory Computer-readable Medium, Method, Apparatus, and Device for a Computer system

(71) Applicants: Aruni NELSON, Rocklin, CA (US); Rajesh POORNACHANDRAN, Portland, OR (US); Robert L. VAUGHN, Portland, OR (US)

(72) Inventors: Aruni NELSON, Rocklin, CA (US); Rajesh POORNACHANDRAN, Portland, OR (US); Robert L. VAUGHN, Portland, OR (US)

(21) Appl. No.: 19/237,052

(22) Filed: Jun. 13, 2025

(51) Int. Cl. G06F 21/62; G06F 40/166; G06F 40/284; G06F 40/40; G06T 11/60

(52) U.S. Cl. CPC G06F 21/6245; G06F 40/166; G06F 40/284; G06F 40/40; G06T 11/60

(57) ABSTRACT

Some aspects of the present disclosure relate to a non-transitory computer-readable medium storing instructions that, when executed by one or more processing circuitries, cause the one or more processing circuitries to perform a method for a computer system, comprising obtaining user input intended for a remote computer system, subdividing the user input into a plurality of discrete segments, processing the plurality of discrete segments to determine at least one segment that contains sensitive information according to a sensitivity criterion, replacing the at least one segment of the user input using synthetic information derived from the sensitive information, with the synthetic information derived from the sensitive information being less sensitive according to the sensitivity criterion, and providing the user input to the remote computer system.

### BACKGROUND

Sharing sensitive information with third-party servers poses significant privacy and security risks. When data is transmitted to these external servers, it becomes vulnerable to unauthorized access and potential data breaches. Third-party servers may not have the same robust security measures that an organization would use to protect its sensitive data. As a result, hackers and cybercriminals may exploit these vulnerabilities to gain access to confidential information, leading to identity theft, financial fraud, or exposure of personal and proprietary business data.

Furthermore, even if the third-party server implements adequate security measures, there remains the risk of misuse of information by the third-party provider itself. This may occur if the provider has not clearly defined data processing and sharing policies or if it engages in unethical practices such as selling data to advertisers without the consent of the individuals involved. Users often have limited oversight and control once their data is shared, making it crucial to trust the third-party's commitment to data protection and privacy.

### BRIEF DESCRIPTION OF THE FIGURES

Some examples of apparatuses and/or methods will be described in the following by way of example only, and with reference to the accompanying figures, in which

FIG. 1a shows a schematic diagram of an example of an apparatus or device for a computer system, and of a computer system comprising such an apparatus or device;

FIG. 1b shows a flowchart of an example of a method for a computer system;

FIG. 2 shows an example implementation of the proposed concept in an Artificial Intelligence Personal Computer (AI PC) with a cloud based rendering system architecture;

FIG. 3 shows an example of sensitivity scoring for filtering private/confidential content;

FIG. 4 shows an example of an AI PC generative AI-based synthetic data augmentation architecture;

FIG. 5 shows an example of a configuration flow;

FIG. 6 shows an example of an operational flow;

FIG. 7 shows a sequence diagram for an example scenario; and

FIG. 8 shows a block diagram of an example computer system or computing device.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

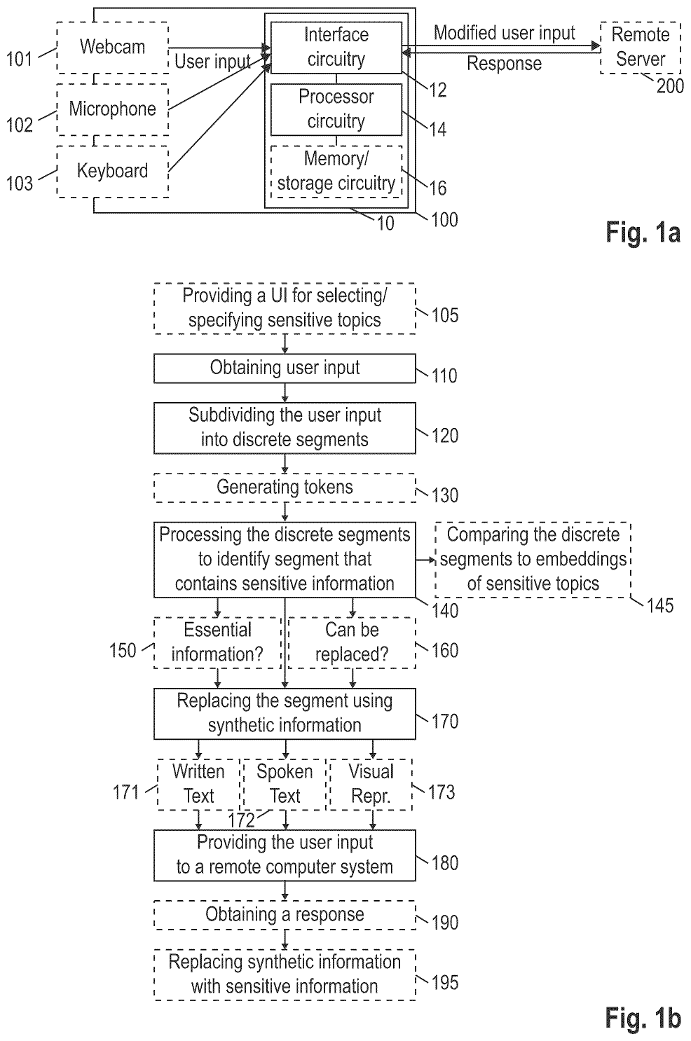

FIG. 1a shows a schematic diagram of an example of an apparatus 10 or device 10 for a computer system 100, and of a computer system 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processor circuitry 14, and (optional) memory/storage circuitry 16. For example, the processor circuitry 14 may be coupled with the interface circuitry 12 and/or with the memory/storage circuitry 16. For example, the processor circuitry 14 may provide the functionality of the apparatus, in conjunction with the interface circuitry 12 (for communicating with other entities inside or outside the computer system 100, e.g., with an optional webcam 101, an optional microphone 102, and/or an optional keyboard 103, each of which may be part of or separate from the computer system 100, and with a remote server 200), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory or storage circuitry 16 or means for storing information 16.

The processor circuitry 14 or means for processing 14 is to obtain user input intended for the remote computer system 200. The processor circuitry 14 or means for processing 14 is to subdivide the user input into a plurality of discrete segments. The processor circuitry 14 or means for processing 14 is to process the plurality of discrete segments to determine at least one segment that contains sensitive information according to a sensitivity criterion. The processor circuitry 14 or means for processing 14 is to replace the at least one segment of the user input using synthetic information derived from the sensitive information. The synthetic information derived from the sensitive information is less sensitive according to the sensitivity criterion. The processor circuitry 14 or means for processing 14 is to provide the user input (i.e., the modified user input with at least one segment being replaced) to the remote computer system.

FIG. 1b shows a flowchart of an example of a corresponding method for a computer system, such as the computer system 100 of FIG. 1a. For example, the method may be performed by the computer system 100, e.g., by an apparatus 10 or device 10 for the computer system 100. The method comprises obtaining 110 the user input intended for the remote computer system 200. The method comprises subdividing 120 the user input into the plurality of discrete segments. The method comprises processing 140 the plurality of discrete segments to determine the at least one segment that contains sensitive information according to the sensitivity criterion. The method comprises replacing 170 the at least one segment of the user input using the synthetic information derived from the sensitive information. The synthetic information derived from the sensitive information is less sensitive according to the sensitivity criterion. The method comprises providing 180 the user input to the remote computer system.

In the following, the features of the apparatus 10, the device 10, and the computer system 100, as well as the corresponding method of FIG. 1b (and a corresponding computer program and a corresponding non-transitory computer-readable medium) will be introduced in more detail with reference to the method of FIG. 1b. Features introduced in connection with the method of FIG. 1b may likewise be included in the corresponding apparatus 10, device 10, and computer system 100, and the corresponding computer program and non-transitory computer-readable medium. In particular, the non-transitory computer-readable medium stores instructions that, when executed by one or more processing circuitries, cause the one or more processing circuitries to perform the method of FIG. 1b. Similarly, the computer program has program code for performing the method of FIG. 1b when the computer program is executed on a computer, a processor, or a programmable hardware component. Finally, the apparatus 10, device 10, and/or computer system 100 of FIG. 1a may perform the method of FIG. 1b.

The proposed concept relates to a mechanism for pre-processing user input that is to be provided to a remote server, for the purpose of improving operational security by avoiding the disclosure of sensitive information. Such sensitive information may include one or more of confidential corporate information (e.g., trade secrets, privileged information, project details/deadlines), confidential private information (e.g., bank account number, social security number, information often used as recovery questions, passwords, etc.), information on disabilities, information on sexual orientation, and personally identifiable information, etc. In the proposed concept, a local proxy is provided that screens user input for sensitive information and replaces the sensitive information (if possible) in a context-aware manner, without altering the general meaning of the user input being transmitted.

The process starts with obtaining 110 the user input intended for the remote computer system 200. This user input may take various forms. For example, the user input may include written textual input (obtained via keyboard 103), spoken textual input (obtained via microphone 102), or visual input, such as image or video input (e.g., image data from a camera, such as the webcam 101 or a still image camera, or image data of a presentation or screenshare during an online meeting.). These inputs are subdivided 120 into the plurality of discrete segments. In particular, the user inputs may be tokenized, i.e., subdivided into discrete segments (tokens), and then converted into embeddings that not only represent the respective discrete segment, but also the context of the segment (i.e., the adjacent segments). In this context, a token is a fragment of text. A token can be as small as a single character or as large as an entire word or subword, depending on how the text is tokenized. In other words, the method may comprise generating 130 tokens representing the respective segments. This is straightforward in the case of written textual input—in this case, tokenization may be directly applied to the written textual input. In other words, the written textual input may be subdivided into discrete segments, with the method comprising generating tokens 130 representing the written textual input of the respective segments. In the case of spoken textual input and visual input, the respective textual information may first be extracted from the respective user input, and then the textual information may be subdivided into discrete segments and encoded into tokens. For example, if the user input comprises spoken textual input, the spoken textual input may be subdivided into discrete segments (e.g., after transcription into text), with the method comprising generating 130 tokens representing the spoken textual input of the respective segments. If the user input comprises a visual input, optical character recognition or image description (e.g., using a large language model capable of processing vision) may be performed on the visual input to determine the textual information contained in the visual input, with the method comprising generating 130 tokens representing the textual information contained in the visual input. In other words, the method may comprise generating 130 tokens representing written textual input or graphical input contained in the respective segments of the visual input. In this case, the textual information may be subdivided into the segments, or the visual input may be subdivided, e.g., using a segmentation model.

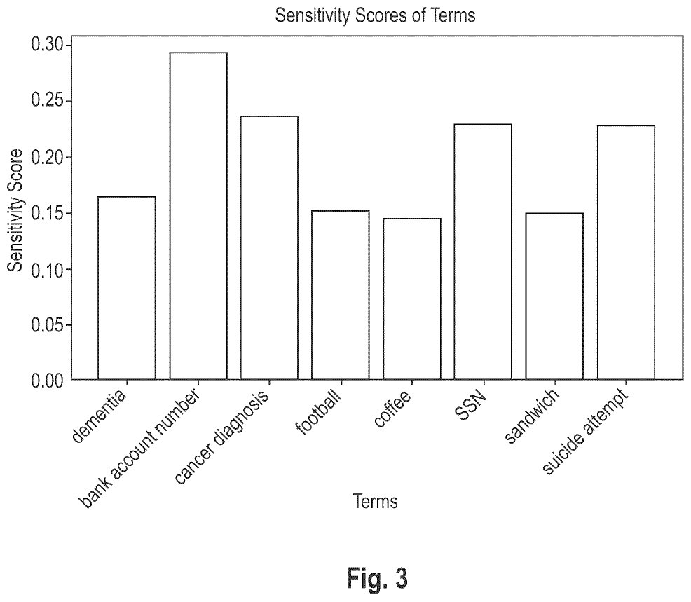

The method comprises processing 140 the plurality of discrete segments to determine the at least one segment that contains sensitive information according to the sensitivity criterion. In other words, for each segment (or token/embedding representing the segment), it is checked whether the segment contains sensitive information according to the sensitivity criterion. This may be achieved by comparing embeddings representing the respective segments (or tokens) to embeddings representing sensitive tokens, and using their distance in embedding space to determine whether the segment is considered sensitive according to the sensitivity criterion. For example, the respective embeddings may be generated using a local language model trained for embedding of tokens. For example, processing the plurality of discrete segments to determine at least one segment that contains sensitive information may comprise comparing 145 the plurality of discrete segments to embeddings of one or more sensitive topics. For example, the sensitivity criterion may be a threshold being used to judge the distance (e.g., cosine distance) between the different embeddings in embedding space. Accordingly, the sensitivity criterion may be based on a distance of the respective segments from the embeddings of the one or more sensitive topics in embedding space. For example, the segment may be considered sensitive if the distance between the embedding of the segment and the embedding of a sensitive topic is lower than the threshold, indicating that the segment is related or similar to the sensitive topic. An example algorithm for determining such a distance is discussed in connection with FIG. 3.

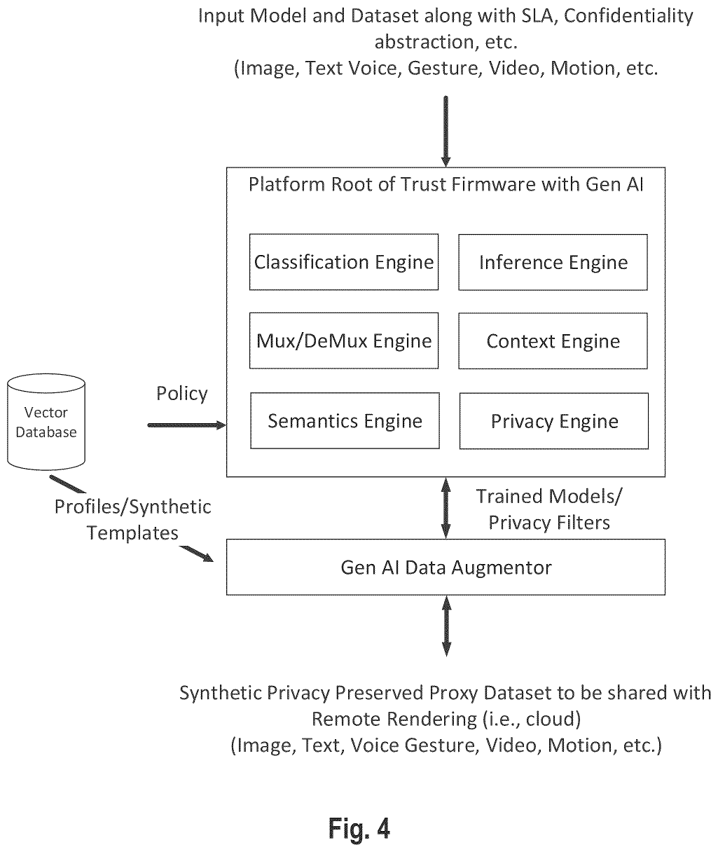

In general, what the user providing the user input (or their employer) considers sensitive can be configured by configuring the sensitive topics. For example, the sensitive topics may be defined separately for the modalities being supported, i.e., different sensitive topics may be defined for written textual input, spoken textual input, and visual input. For example, a wide range of sensitive topics may be pre-defined, and the user (or company administrator) may select a subset of the pre-defined topics. In other words, at least a subset of the one or more sensitive topics are selected by a user from a plurality of sensitive topics. Additionally, or alternatively, the user may manually define sensitive topics, e.g., by typing them into a text field. In other words, at least a subset of the one or more sensitive topics are topics manually defined by a user. For example, a user interface may be provided to let the user define the sensitive topics. In other words, the method may comprise providing 105 a user interface for selecting or specifying sensitive topics. For example, FIG. 4 shows an example of how sensitive topics can be specified/selected using a user dashboard.

In some cases, it may not be possible to replace a segment, for various reasons. For example, in some cases, the sensitive information is actually required in the context of the user input. Thus, the method may comprise determining whether the at least one segment that contains sensitive information is deemed essential information in the context of the user input provided to the remote computer system, and preserving the at least one segment of the user input if the at least one segment is deemed essential. For example, this may be done by prompting a local large language model or small language model to check whether, in the context of the user input, the at least one segment is deemed essential (in the context of the present disclosure, a language model having at least a half billion parameters is considered a large language model, and a language model having fewer than a half billion parameters is considered a small language model). Similarly, in some cases, there is no adequate replacement for the sensitive segment. In this case, the segment may be removed entirely or replaced by a pre-defined marker (e.g., a beep in the case of spoken textual input, a black, white, or blurry overlay in case of visual input, or a pre-defined term such as “XXXXX” or “[redacted]” in case of written textual input. Thus, the method may comprise determining 160 whether the at least one segment of the user input can be replaced with information derived from the sensitive information, and removing the at least one segment of the user input or replacing the at least one segment of the user input with a pre-defined marker if the determination is negative.

In other cases, i.e., if a segment is deemed sensitive and can be replaced, the method comprises replacing 170 the at least one segment of the user input using the synthetic information derived from the sensitive information. In this context, the synthetic information is information having the same general meaning as the sensitive information, while being less sensitive according to the sensitivity criterion. For example, in the textual input “I have been experiencing memory loss and am worried about early-stage dementia”, the segments “early-stage dementia” and “memory loss” may be replaced by “cognitive decline” and “difficulty recalling information”, resulting in the modified user input “I have been experiencing difficulty recalling information and am worried about cognitive decline.” These replacements may be provided by a local LLM. In other words, the synthetic information may be derived from the sensitive information using a language model, and in particular a local small language model or large language model being run on the computer system itself. For example, the language model may be prompted to provide less sensitive alternatives to the segments deemed sensitive.

In case of written textual input, performing the replacement is straightforward—in this case, the language model can directly perform the replacement. In other words, replacing the at least one segment of the user input may comprise generating 171 written text, e.g., using the language model, based on the synthetic information derived from the sensitive information. In other words, e.g., in case of spoken textual input, the synthetic information may be transformed into spoken text, e.g., using a text-to-speech machine learning model (e.g., the language model or another language model), so it can be integrated into the user input. In other words, replacing the at least one segment of the user input may comprise generating 172 spoken text based on the synthetic information derived from the sensitive information. Finally, if the user input comprises visual input, replacing the at least one segment of the user input comprises generating 173 a visual replacement for the at least one segment containing sensitive information based on the synthetic information derived from the sensitive information. For example, an image generation model or a graphics library may be used for generating the visual replacement. Finally, the modified user input 180 is provided to the remote computer system.

To reduce confusion for the user, the replacement may be reversed in the response obtained from the remote server. For example, the method may comprise obtaining 190 a response from the remote computer system after providing the user input, and replacing 195 the synthetic information included in the response with the original sensitive information in the response from the remote computer system. For example, information may be stored regarding the segments being replaced, with the response being checked for the synthetic information based on the stored information, and the synthetic information being replaced by the original sensitive information.

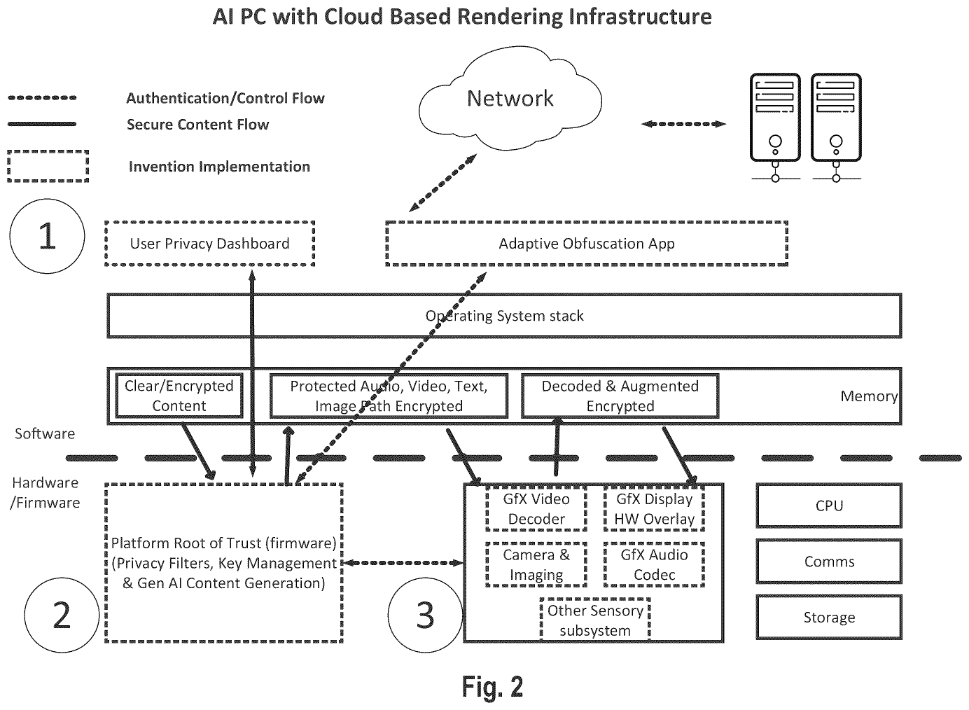

The proposed concept necessarily deals with sensitive information, e.g., across applications of the computer system. To avoid this becoming a highly valuable target for malicious actors, the proposed concept may at least partially be performed in a way that is inaccessible to other applications running on the computer system. In particular, the proposed concept may at least partially be performed on a firmware layer, secured by a trusted execution environment of the processor of the computer system. In other words, at least the acts of subdividing the user input, processing the plurality of discrete segments to determine at least one segment that contains sensitive information, and replacing the at least one segment of the user input (and optionally generating the tokens, and replacing the synthetic information included in the response with the original sensitive information) may be performed in a firmware layer of the computer system, with the user input being routed through the firmware layer. For example, the respective functionality of the firmware layer may be secured by a trusted execution environment of the computer system. FIGS. 2, 4, and 6 give examples of how the proposed concept can be performed by the root of trust of the computer system 100.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, or any means for processing, such as a processor, a computer, or a programmable hardware component operable with accordingly adapted software. In other words, the described function of the processor circuitry 14 or means for processing may also be implemented in software, which is then executed on one or more programmable hardware components. Such hardware components may comprise a general-purpose processor, a Digital Signal Processor (DSP), a Field-Programmable Gate Array (FPGA), such as an FPGA implementing processor or (micro-) controller logic, a micro-controller, etc. For example, on an FPGA, a microcontroller design can be programmed and isolated from tenant designs that can then use the microcontroller as if it were a discrete microcontroller. In this case, the FPGA-based microcontroller may comprise the processor circuitry or means for processing 14, the interface circuitry or means for communicating 12, and/or the memory or storage circuitry/means for storing information 16.

For example, the memory or storage circuitry 16 or means for storing information 16 may comprise a volatile memory, e.g., random access memory, such as dynamic random-access memory (DRAM), and/or at least one element of the group consisting of a computer readable storage medium, such as a magnetic or optical storage medium, e.g., a hard disk drive, a flash memory, a Floppy-Disk, Random Access Memory (RAM), such as static Random Access Memory of an FPGA, block Random Access Memory of an FPGA, distributed Random Access Memory of an FPGA, Programmable Read Only Memory (PROM), Erasable Programmable Read Only Memory (EPROM), an Electronically Erasable Programmable Read Only Memory (EEPROM), or a network storage.

More details and aspects of the method, apparatus, and device for the computer system and of the computer system are mentioned in connection with the proposed concept or one or more examples described above or below (e.g. FIGS. 2 to 8). The method, apparatus, and device for the computer system and the computer system may comprise one or more additional optional features corresponding to one or more aspects of the proposed concept or one or more examples described above or below.

Various examples of the present disclosure relate to system software-driven Privacy-Preserved Generative AI (PPGAI) for AI PCs multi-modality usage. The proposed concept provides intelligent identification, filtering, modification and substitution of confidential/personal and private information while maintaining contextual relevance when using cloud or edge services. External responses may be re-synthesized, to generate contextually relevant data for user consumption. The proposed concept may tone down the sensitivity of confidential and private information. It may provide end-to-end protection of confidential and private information with emphasis on input control.

Generative AI multi-modality use-cases for AI PCs often involve collecting confidential and private information of public/enterprise users, which are input into generative AI (GenAI) models to generate new content. An example use case to illustrate the problem relates to a physically challenged user requiring corrective settings to consume AI PC content. There has been some development in adaptive displays, which correct the displayed content and use a filter on the device to correct the display based on a user's prescription (developed by Berkeley and the Massachusetts Institute of Technology). However, this is limited, with no support for privacy/confidentiality for cloud-based content rendering (e.g., Netflix, Remote Gaming/Desktop), which would require knowledge of a user's limitation to be exposed to edge/cloud to adapt the content for user needs.

This brings up the following challenges: In some computer systems, there is no single privacy dashboard that a user can use to configure different levels of privacy filters across one or more hardware and software IP (Intellectual Property) blocks being used in the AI PC. For example, this may enable allowing text tokens to have a certain privacy filter versus camera/microphone usage. Some computer systems might not identify the data flow and dependency graph across all the IP/XPUs (X Processing Units, a generic term to cover different types of processing units) used to ensure that the entire pipeline abides by the lowest common denominator security/privacy policies. Some computer systems may lack the capability to perform synthetic data generation with RAG augmentation to abstract users' privacy when GenAI queries must be augmented beyond the local AI PC to edge or cloud based on contextual relevance.

With the proposed concept, sensitive information, such as user disabilities, is abstracted from the cloud, and the local AI PC can perform the augmentation in real-time with or without local GenAI. It may provide a user-controlled and context-driven (work setup, home setup, doctor-patient conversations, multi-company conversations, etc.) privacy exposure to different 3rd party content providers such as Netflix, YouTube, WebEx, Zoom, Teams, etc., but complement augmented rendering locally within the AI PC, e.g., with TEE (Trusted Execution Environment) support. The focus of the proposed concept is on the system software, to support Gen AI use cases for AI PCs. The proposed concept is not focused on the GenAI algorithms themselves.

Some approaches for preventing a user from entering sensitive information while using cloud or edge services may deploy filters based on Boolean decisions on what is allowed as input to the respective remote applications, not accounting for different levels of filters based on a user's privacy or the context in which the user is using that application. For example, in the use case where a corporate employee intends to use a conversational AI system, such as ChatGPT, for obtaining a certain response with their inputs, there may be a corporate filter which prompts the user to not post any sensitive or proprietary content, and it may prevent the user from entering any input which may contain certain keywords considered potentially proprietary. With the development of features that are user-oriented, such as adaptive displays which correct the displayed content and use a physical filter on the device to correct the display based on a user's prescription, it is important to protect a user's private information.

In an example implementation, the proposed concept leans on one or more of three contextual attention mechanisms: (1) locally maintaining the original context of the user inputs/user data, (2) generating synthetic content to obfuscate sensitive and private information while maintaining proximity to original content when using online cloud and edge services (using semantic vector analysis for deterministic sensitivity quantification to address the variability and lack of determinism in LLM-based sensitivity detection), and (3) mapping of the response from the cloud/edge services to the original context.

The proposed concept may involve collaboration across system software/firmware agents across AI PC XPUs. It may provide a privacy dashboard that a user can use to configure different levels of privacy filters across one or more hardware and software IP blocks being used in the AI PC. For example, text tokens may be allowed to have a different privacy filter than camera/microphone usage. Based on the use case, the proposed concept may identify the data flow and dependency graph across the IP/XPUs used to ensure the entire pipeline abides by the lowest common denominator privacy policies. Based on the configured privacy policies, the AI PC Gen AI may perform synthetic data generation with RAG augmentation to abstract users' privacy whenever content rendering is driven by the edge or cloud based on contextual relevance. Bi-directional synthetic data generation may be performed. For example, content (user input) leaving the AI PC may be formatted—from local user preference to remote user's needs for outgoing (e.g., Facetime video call) and dynamically augmented inbound content for local user's need (e.g., larger pixels to accommodate visual needs) with TEE support. To address the variability and lack of determinism in LLM-based sensitivity detection, the proposed concept proposes an embedding-based scoring method. By calculating the semantic distance of terms from neutral concepts, this approach provides a consistent, reproducible, and quantitative measure of sensitivity, independent of LLM probabilistic outputs. This enables reliable privacy protection and data handling. It may provide privacy filters that are applicable for both enterprise users as well as non-enterprise scenarios administered via platform TEE.

The proposed concept may provide a user interface allowing input from the user to assign privacy filters. It may support dynamic Gen AI content augmentation based on user-configured privacy filters. For example, warnings and notification pop-ups may be provided on the AI PC indicating that prohibited outgoing content was modified.

FIG. 2 shows an example implementation of the proposed concept in an Artificial Intelligence Personal Computer (AI PC) with a cloud based rendering system architecture. Any platform Root of Trust component may host the firmware, which spawns the privacy filters based on user context. One implementation example of the proposed concept may employ a latent space analysis, to identify neighboring embeddings in lower dimensional space and select the closest but nonsensitive wording for sensitive and confidential information entered by the user (original context). Latent space is like the analysis of the embedding vectors.

Then, from a curated list of candidate words, a substitution of sensitive/confidential information while maintaining relevance to the original context may be synthesized, thereby reducing the similarities to the sensitive topics. A lower sensitivity can be quantified through a “distance” from neutral embeddings.

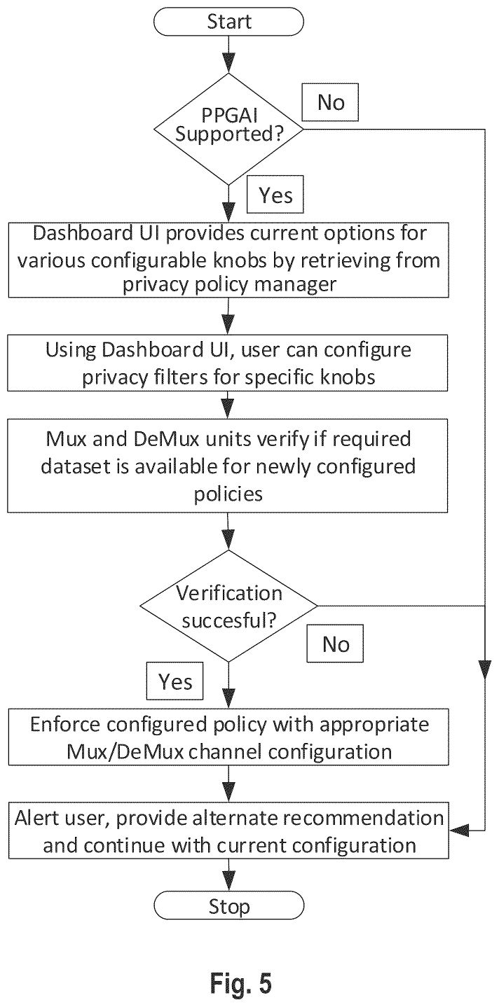

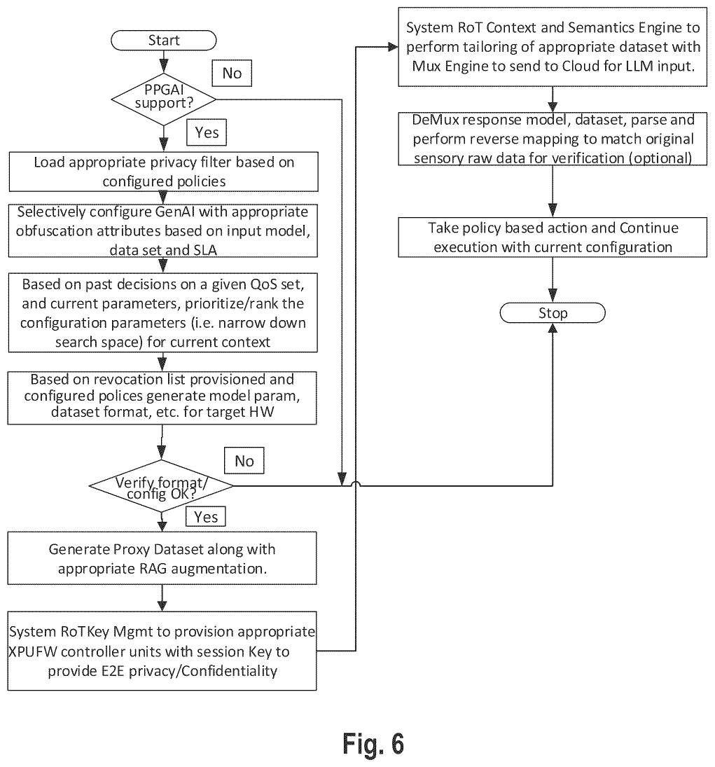

In the example illustrated in FIG. 2, on Intel platforms, the Converged Security and Manageability Engine—CSME, functioning as the Root of Trust, may be responsible for the generation of privacy filters for an E2E (End-to-End) GenAI-based AI PC with cloud-based rendering. FIG. 2 shows the key firmware agents within the Intel® platform that are key to the proposed inventive claims. FIG. 5 shows the configurational flow across the SW/FW boundary interfaces between the application level (dashboard, streaming app) and platform Root of Trust with XPU microcontroller firmware. FIG. 6 shows the operational flow of the GenAI Root of Trust component for the mux/de-mux in an AlPC-Cloud interactive rendering use-case.

In FIG. 2, the proposed concept is shown across various components of a computer system. On the software side, a user privacy dashboard (1) is provided, being executed on top of the operating system stack, with the user privacy dashboard (1) communicating with the platform root of trust (2). On top of the operating system stack, an adaptive obfuscation application is provided, communicating with the platform root of trust (2), and, via the network, with one or more remote servers. In memory, clear/encrypted content, protected/encrypted audio, video, text, and image paths, and decoded and augmented (encrypted) information are held. On the hardware side, the platform root of trust (2), implemented in firmware, provides the privacy filters, key management, and GenAI content generation. The platform root of trust (2) interacts with the hardware components (3) of the computer system, such as the graphics video decoder, camera and imaging hardware, graphics display hardware overlay, graphics audio codec, and other sensory subsystems. The computer system further comprises a CPU (Central Processing Unit), communication circuitry, and storage.

The proposed concept may be built on one or more key components. These components may include the privacy dashboard (1) that a user can use to configure different levels of privacy filters across one or more hardware and software IP blocks being used in the AI PC. For example, such a privacy dashboard may allow text tokens to be judged against a different privacy filter versus camera/microphone usage. These components may comprise one or more Root of Trust Firmware agents. For example, a data flow/context agent may be used. Based on the use case, it may identify the data flow and dependency graph across the IP/XPUs used, and ensure that the entire pipeline abides by the lowest common denominator privacy policies.

Based on the configured privacy policies, the AI PC Gen AI may be used to perform synthetic data generation with RAG augmentation to abstract users' privacy, e.g., whenever content rendering is driven by edge or cloud based on contextual relevance. Synthetic data generation may be bi-directional—i.e., content leaving the AI PC would be formatted from local user preference to remote user's needs for outgoing content (e.g., Facetime video call) and augment inbound content to accommodate local user's needs (e.g., larger pixels to accommodate visual needs) dynamically with TEE support. Privacy filters may be applicable for both enterprise users as well as non-enterprise scenarios administered via the platform TEE (i.e., the platform Root of Trust). Multiplexing/Demultiplexing agents may assist in the format conversion from local to remote and vice-versa with the support from a semantics engine (for format accuracy check) with appropriate context relevance. It may use an embedding-based scoring method. By calculating the semantic distance of terms from neutral concepts, this approach provides a consistent, reproducible, and quantitative measure of sensitivity, independent of LLM probabilistic outputs. This enables reliable privacy protection and data handling.

In an example implementation, a Python script was used to measure the semantic sensitivity of text terms using embedding analysis. It loads a pre-trained DistilBERT model to generate vector representations of input terms (both sensitive and neutral). By calculating the cosine similarity between sensitive term embeddings and a set of neutral term embeddings, it computes a quantitative sensitivity score. Higher scores indicate greater semantic distance from neutral concepts, suggesting higher sensitivity. The script then visualizes these scores and the individual cosine similarities, providing a deterministic measure of term sensitivity.

In the following, this example implementation is presented:

```
import numpy as np
import matplotlib.pyplot as plt
import torch
from transformers import AutoTokenizer, AutoModel
from sklearn.metrics.pairwise import cosine_similarity
# Load DistilBERT tokenizer and model
model_name = “distilbert-base-uncased”
tokenizer = AutoTokenizer.from_pretrained(model_name)
model = AutoModel.from_pretrained(model_name)
# Function to generate embeddings for queries
def generate_embedding(text):
    inputs = tokenizer(text, return_tensors=“pt”, truncation=True,
padding=True, max_length=512)
  with torch.no_grad( ):
    outputs = model(**inputs)
  return outputs.last_hidden_state.mean(dim=1).squeeze( ).numpy( )
# Define sensitive terms to test
sensitive_terms = [“dementia”, “bank account number”, “cancer
diagnosis”,
“football”, “coffee”, “SSN”, “sandwich”, “suicide attempt”]
# Define neutral terms
neutral_terms = [“everyday life”, “general topic”, “common word”,
“conversation”, “information”, “summer”,“tree”,“jacket”]
# Compute embeddings for sensitive and neutral terms
sensitive_embeddings = np.array([generate_embedding(term) for
term in
sensitive_terms])
neutral_embeddings = np.array([generate_embedding(term) for
term in
neutral_terms])
# Function to compute sensitivity score
def compute_sensitivity_score(term_embedding,
neutral_embeddings):
    similarities = cosine_similarity(term_embedding.reshape(1, −1),
neutral_embeddings)
  avg_similarity = np.mean(similarities)
  sensitivity_score = 1 − avg_similarity # Higher score = more
  sensitive
  return sensitivity_score
# Compute and display sensitivity scores
sensitivity_scores = [ ]
for term, embedding in zip(sensitive_terms, sensitive_embeddings):
  score = compute_sensitivity_score(embedding,
  neutral_embeddings)
  sensitivity_scores.append(score)
  print (f“Term: ‘{term}’, Sensitivity Score: {score:.4f}”)
# Optional: Visualize the distribution of sensitivity scores
plt.figure(figsize=(8, 6))
plt.bar(sensitive_terms, sensitivity_scores)
plt.title(“Sensitivity Scores of Terms”)
plt.xlabel(“Terms”)
plt.ylabel(“Sensitivity Score”)
plt.xticks(rotation=45, ha=“right”)
plt.tight_layout( )
plt.show( )
# Scatter plot for a highly sensitive term (e.g., “bank account
number”)
# sensitive_term_to_plot = “cancer diagnosis”
sensitive_term_to_plot = “SSN”
sensitive_index = sensitive_terms.index(sensitive_term_to_plot)
sensitive_embedding_to_plot =
sensitive_embeddings[sensitive_index]
similarities_to_neutral =
cosine_similarity(sensitive_embedding_to_plot.reshape(1, −1),
neutral_embeddings)[0]
plt.figure(figsize=(8, 6))
plt.scatter(range(len(neutral_terms)), similarities_to_neutral)
plt.xticks(range(len(neutral_terms)), neutral_terms, rotation=45,
ha=“right”)
plt.title(f“Cosine Similarity of ‘{sensitive_term_to_plot}’ to
Neutral
Terms”)
plt.xlabel(“Neutral Terms”)
plt.ylabel(“Cosine Similarity”)
plt.tight_layout( )
plt.show( )
# Print the similarities
print (f“\nCosine Similarities of ‘{sensitive_term_to_plot}’ to
Neutral
Terms:”)
for i, neutral_term in enumerate(neutral_terms):
      print (f“{sensitive_term_to_plot} vs. {neutral_term}:
{similarities_to_neutral[i]:.4f}”)
```

FIG. 3 shows an example of sensitivity scoring for filtering private/confidential content, as generated by the above script. In FIG. 3, each sensitive term (e.g., dementia, bank account number, etc.) is tested for sensitivity and correlated (via cosine similarity) to every neutral term, and the resulting similarity values are then averaged.

### EXAMPLE: COSINE SIMILARITIES OF ‘SSN’ TO NEUTRAL TERMS

SSN vs. everyday life: 0.7587
SSN vs. general topic: 0.7412
SSN vs. common word: 0.7667
SSN vs. conversation: 0.7855
SSN vs. information: 0.7757
SSN vs. summer: 0.7769
SSN vs. tree: 0.7956
SSN vs. jacket: 0.7702

The high cosine similarities between “SSN” and neutral terms indicate some semantic overlap, but the calculated sensitivity score still identifies “SSN” as relatively sensitive. This reflects that, while “SSN” shares general semantic features, its high specificity and privacy implications result in a higher sensitivity score compared to common terms. The quantitative analysis captures the nuanced relationship, acknowledging semantic overlap while accurately classifying “SSN” as a sensitive term due to its specific nature and potential privacy risks.

In the proposed concept, the system Root of Trust may perform attestation (using provisioned credentials and a revocation list) across the smart microcontroller firmware entities driving the XPUs in the dependency graph. Post successful attestation, a Content Encryption Key (CEK) for the particular session may be derived and provisioned to the respective XPU firmware for end-to-end protection.

FIG. 4 shows an example of an AI PC generative AI-based synthetic data augmentation architecture. An input model and dataset are provided along with a Service Level Agreement (SLA) and confidentiality abstraction (image, text, voice, gesture, video, motion) to the platform Root of Trust with GenAI. The platform Root of Trust with GenAI comprises a classification engine, an inference engine, a multiplexing/demultiplexing engine, a context engine, a semantics engine, and a privacy engine. It receives a policy from a vector database. Trained models/privacy filters are exchanged with a GenAI data augmenter, which receives profiles/synthetic templates from a vector database. The GenAI data augmenter uses a synthetic privacy-preserved proxy dataset to be shared with remote rendering (i.e., cloud) (image, text, voice, gesture, video, motion).

FIG. 5 shows an example of a configuration flow. If PPGAI is supported, the dashboard user interface provides current operations for various configurable knobs by retrieving information from the privacy policy manager. Using the dashboard UI, the user can configure privacy filters for specific knobs. Multiplexing and demultiplexing units verify if the required dataset is available for newly configured policies. If verification is successful, the configured policy is enforced with appropriate multiplexing/demultiplexing channel configuration. The user is alerted and provided with an alternate recommendation, or may continue with the current configuration.

FIG. 6 shows an example of an operational flow. If PPGAI is supported, an appropriate privacy filter is loaded based on the configured policies. The GenAI is selectively configured with appropriate obfuscation attributes based on the input model, dataset, and SLA. Based on past decisions on a given QoS (Quality of Service) set, and current parameters, the configuration parameters may be prioritized/ranked (narrowing down the search space) for the current context. Based on the revocation list provisioned and configured policies, the model parameters, dataset format, etc., for the target hardware are generated. If the format/configuration is OK, a proxy dataset is generated along with appropriate RAG (Retrieval-Augmented Generation). System Root of Trust key management is used to provision the appropriate XPU firmware controller units with a session key to provide E2E privacy/confidentiality. The System Root of Trust Context Engine and Semantics Engine are used to perform tailoring of an appropriate dataset with the multiplexing engine to send to the cloud for LLM input. Demultiplexing may be performed on the response model, dataset, parsing, and performing reverse mapping to match the original sensory raw data for verification (optional). Policy-based action may be taken, and execution may be continued with the current configuration.

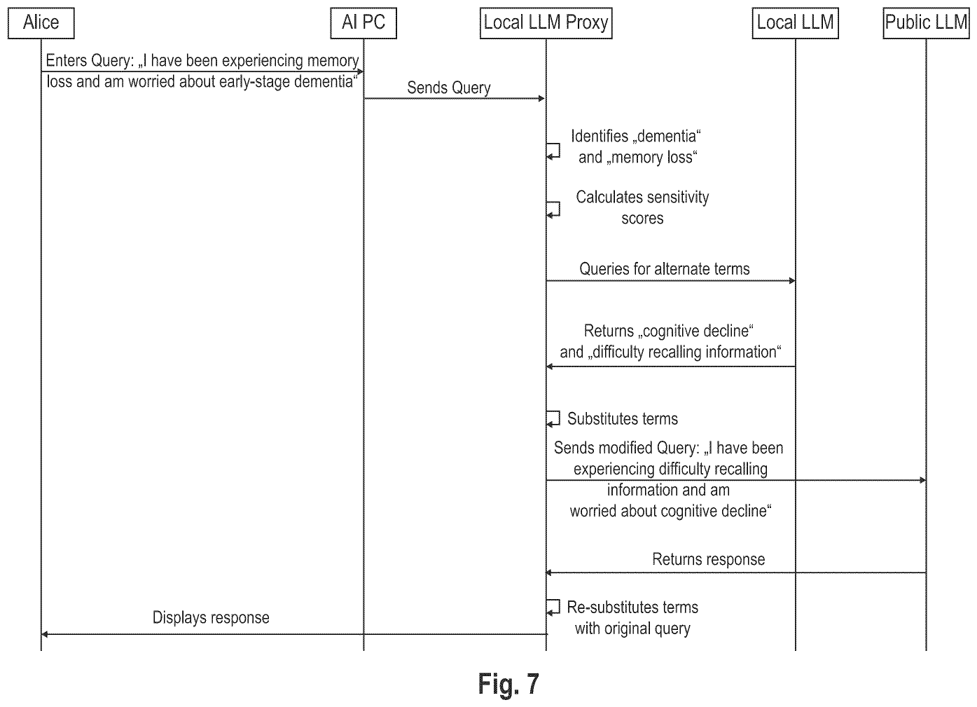

FIG. 7 shows a sequence diagram for an example scenario. In the example scenario, Alice is using an Intel AI PC. It leverages an NPU with a local LLM proxy. The LLM proxy evaluates user queries for sensitive or privacy-related terms/phrases and can provide substituted terms/phrases if quantified as sensitive. Suppose Alice, a user of an LLM, enters the query: “I have been experiencing memory loss and am worried about early-stage dementia.” The system identifies that “dementia” and “memory loss” are sensitive by leveraging the embedding-based sensitivity scoring methods discussed herein. The system then queries the local LLM for alternate terms with lower quantified sensitivity scoring. The local LLM might suggest “cognitive decline” and “difficulty recalling information” as substitutes that have been quantitatively scored to increase determinism. The query then proceeds to the hosted “public” LLM as: “I have been experiencing difficulty recalling information and am worried about cognitive decline.” The public LLM returns a response to the local LLM proxy, which re-substitutes the substituted terms with the terms from the original query. The local LLM proxy then displays the response (with the re-substituted terms) to Alice.

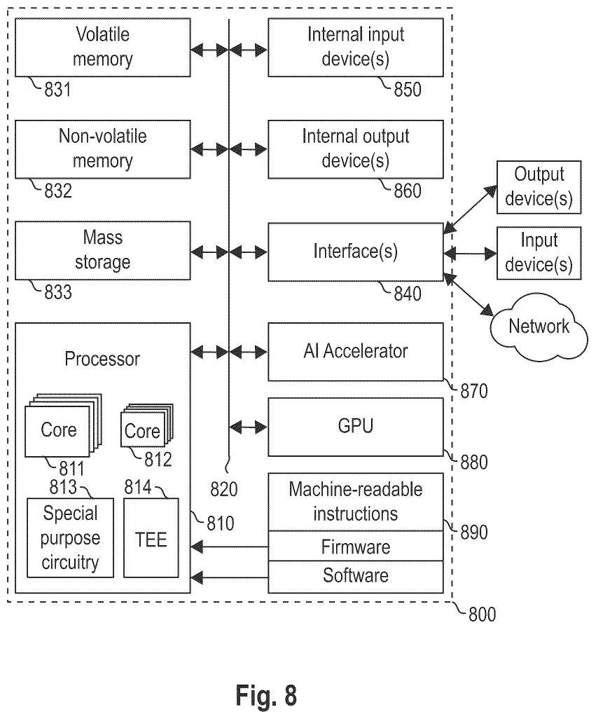

FIG. 8 is a block diagram of an example computer system 800 or computing device 800 structured to execute and/or instantiate the machine-readable instructions and/or operations of FIGS. 1a to 7 to implement the apparatus 10, device 10, and/or computer system 100 of FIGS. 1a to 7. The computer system 800 or computing device 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The computer system 800 or computing device 800 of the illustrated example includes processor circuitry 810. The processor circuitry 810 of the illustrated example is hardware. For example, the processor circuitry 810 can be implemented by one or more integrated circuits, logic circuits, FPGAs (Field-Programmable Gate Arrays) microprocessors, CPUs (Central Processing Units), GPUs (Graphics Processing Units), DSPs (Digital Signal Processors), and/or microcontrollers from any desired family or manufacturer. The processor circuitry 810 may be implemented by one or more semiconductor based (e.g., silicon based) devices. For example, the processor circuitry 810 may provide the functionality of the computer system 800 or computing device 800.

The processor circuitry 810 comprises one or more processor cores 811, 812. For example, the processor circuitry 810 may have heterogeneous cores. Heterogeneous cores in CPUs refer to the use of different types of cores within a single processor, typically combining high-performance (BIG) cores with power-efficient (LITTLE) cores. Thus, the one processor circuitry 810 may comprise one or more BIG cores 811 and one or more LITTLE cores 812. BIG cores are designed for performance-intensive tasks and provide higher processing power, but they consume more energy. LITTLE cores, on the other hand, are optimized for energy efficiency and handle less demanding tasks to prolong battery life and reduce power consumption.

The processor circuitry 810 of the illustrated example is in communication, e.g., via one or more bus interfaces 820, with a main memory including a volatile memory 831 and a non-volatile memory 832. The volatile memory 831 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 832 may be implemented by flash memory and/or any other desired type of memory device. Access to the main memory 831, 832 of the illustrated example is controlled by a memory controller, which may be implemented by a special purpose circuitry 813 of the processor circuitry 810.

The computer system 800 or computing device 800 of the illustrated example also includes one or more mass storage devices 833 to store software and/or data. Examples of such mass storage devices 833 include magnetic storage devices, optical storage devices, floppy disk drives, HDDs, CDs, Blu-ray disk drives, redundant array of independent disks (RAID) systems, solid state storage devices such as flash memory devices, and DVD drives.

The computer system 800 or computing device 800 of the illustrated example also includes interface circuitry 840. The interface circuitry 840 may be implemented by hardware in accordance with any type of interface standard, such as an Ethernet interface, a WiFi interface, a cellular modem, a universal serial bus (USB) interface, a Bluetooth® interface, a near field communication (NFC) interface, a PCI (Peripheral Component Interconnect) interface, and/or a PCIe (Peripheral Component Interconnect express) interface. For example, the interface circuitry 840 of the illustrated example may include a communication device such as a transmitter, a receiver, a transceiver, a modem, a residential gateway, a wireless access point, and/or a network interface to facilitate exchange of data with external machines (e.g., computing devices of any kind) by a network. The communication can be by, for example, an Ethernet connection, a digital subscriber line (DSL) connection, a telephone line connection, a coaxial cable system, a satellite system, a line-of-site wireless system, a cellular telephone system, an optical connection, etc.

In the illustrated example, one or more internal input devices 850 and/or one or more external input devices are connected to the interface circuitry 840 or the bus 820. The input device(s) permit(s) a user to enter data and/or commands into the processor circuitry 810. The input device(s) can be implemented by, for example, an audio sensor, a microphone, a camera (still or video), a keyboard, a button, a mouse, a touchscreen, a track-pad, a trackball, an isopoint device, and/or a voice recognition system.

One or more internal output devices 860 and/or one or more external output devices are also connected to the interface circuitry 840 of the illustrated example. The output devices 860 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The computer system 800 or computing device 800 of the illustrated example, thus, typically includes a graphics driver card, a graphics driver chip, and/or graphics processor circuitry such as a GPU 813, 880, which may correspond to or be part of the processor circuitry 810, for example as special purpose circuitry 813 or as cores 811, 812) or separate from the processor 810, for example as separate GPU 880.

The computer system 800 or computing device 800 of the illustrated example may include an AI Accelerator 870. For example, the AI Accelerator 870 may be configured to improve the computational speed and efficiency of machine learning tasks by executing parallel processing operations tailored for neural network models. The AI Accelerator 870 may include hardware such as a Graphics Processing Units (GPUs), Tensor Processing Units (TPUs), or other specialized processors designed to handle large volumes of data with low latency.

The computer system 800 or computing device 800 of the illustrated example includes machine-readable 890. For example, the machine-readable instructions may be part of a firmware or software of the computer system 800 or computing device 800. The machine-readable instructions 890 may be stored in the mass storage device 833, in the volatile memory 831, in the non-volatile memory 832, and/or on a removable non-transitory computer readable storage medium such as a CD or DVD.

In the following, some examples of the proposed concept are presented:

An example (e.g., example 1) relates to a non-transitory computer-readable medium storing instructions that, when executed by one or more processing circuitries, cause the one or more processing circuitries to perform a method for a computer system, comprising obtaining user input intended for a remote computer system, subdividing the user input into a plurality of discrete segments, processing the plurality of discrete segments to determine at least one segment that contains sensitive information according to a sensitivity criterion, replacing the at least one segment of the user input using synthetic information derived from the sensitive information, with the synthetic information derived from the sensitive information being less sensitive according to the sensitivity criterion, and providing the user input to the remote computer system.

Another example (e.g., example 2) relates to a previous example (e.g., example 1) or to any other example, further comprising that the user input comprises written textual input, with the written textual input being subdivided into discrete segments, with the method comprising generating tokens representing the written textual input of the respective segments.

Another example (e.g., example 3) relates to a previous example (e.g., one of the examples 1 or 2) or to any other example, further comprising that replacing the at least one segment of the user input comprises generating written text based on the synthetic information derived from the sensitive information

Another example (e.g., example 4) relates to a previous example (e.g., one of the examples 1 to 3) or to any other example, further comprising that the user input comprises spoken textual input, with the spoken textual input being subdivided into discrete segments, with the method comprising generating tokens representing the spoken textual input of the respective segments.

Another example (e.g., example 5) relates to a previous example (e.g., example 4) or to any other example, further comprising that replacing the at least one segment of the user input comprises generating spoken text based on the synthetic information derived from the sensitive information.

Another example (e.g., example 6) relates to a previous example (e.g., one of the examples 1 to 5) or to any other example, further comprising that the user input comprises visual input, with replacing the at least one segment of the user input comprising generating a visual replacement for the at least one segment containing sensitive information based on the synthetic information derived from the sensitive information.

Another example (e.g., example 7) relates to a previous example (e.g., example 6) or to any other example, further comprising that the visual input is image data of a camera.

Another example (e.g., example 8) relates to a previous example (e.g., one of the examples 6 or 7) or to any other example, further comprising that the visual input is image data of a presentation or screenshare during an online meeting.

Another example (e.g., example 9) relates to a previous example (e.g., one of the examples 6 to 8) or to any other example, further comprising that the visual input is subdivided into segments, with the method comprising generating tokens representing written textual input or graphical input contained in the respective segments of the visual input.

Another example (e.g., example 10) relates to a previous example (e.g., one of the examples 1 to 9) or to any other example, further comprising that the synthetic information is derived from the sensitive information using a language model.

Another example (e.g., example 11) relates to a previous example (e.g., one of the examples 1 to 10) or to any other example, further comprising that the method comprises determining whether the at least one segment that contains sensitive information is deemed essential information in the context of the user input provided to the remote computer system, and preserving the at least one segment of the user input if the at least one segment is deemed essential.

Another example (e.g., example 12) relates to a previous example (e.g., one of the examples 1 to 11) or to any other example, further comprising that the method comprises determining whether the at least one segment of the user input can be replaced with information derived from the sensitive information, and removing the at least one segment of the user input or replacing the at least one segment of the user input with a pre-defined marker if the determination is negative.

Another example (e.g., example 13) relates to a previous example (e.g., one of the examples 1 to 12) or to any other example, further comprising that processing the plurality of discrete segments to determine at least one segment that contains sensitive information comprises comparing the plurality of discrete segments to embeddings of one or more sensitive topics.

Another example (e.g., example 14) relates to a previous example (e.g., example 13) or to any other example, further comprising that at least a subset of the one or more sensitive topics are selected by a user from a plurality of sensitive topics.

Another example (e.g., example 15) relates to a previous example (e.g., one of the examples 13 or 14) or to any other example, further comprising that at least a subset of the one or more sensitive topics are topics manually defined by a user.

Another example (e.g., example 16) relates to a previous example (e.g., one of the examples 13 to 15) or to any other example, further comprising that the method comprises providing a user interface for selecting or specifying sensitive topics.

Another example (e.g., example 17) relates to a previous example (e.g., one of the examples 13 to 16) or to any other example, further comprising that the sensitivity criterion is based on a distance of the respective segments from the embeddings of the one or more sensitive topics in embedding space.

Another example (e.g., example 18) relates to a previous example (e.g., one of the examples 1 to 17) or to any other example, further comprising that the method comprises obtaining a response from the remote computer system after providing the user input, and replacing the synthetic information included in the response with the original sensitive information in the response of the remote computer system.

Another example (e.g., example 19) relates to a previous example (e.g., one of the examples 1 to 18) or to any other example, further comprising that at least the acts of subdividing the user input, processing the plurality of discrete segments to determine at least one segment that contains sensitive information and replacing the at least one segment of the user input are performed in a firmware layer of the computer system, with the user input being routed through the firmware layer.

Another example (e.g., example 20) relates to a previous example (e.g., example 19) or to any other example, further comprising that the respective functionality of the firmware layer is secured by a trusted execution environment of the computer system.

An example (e.g., example 21) relates to a method for a computer system, comprising obtaining (110) user input intended for a remote computer system, subdividing (120) the user input into a plurality of discrete segments, processing (140) the plurality of discrete segments to determine at least one segment that contains sensitive information according to a sensitivity criterion, replacing (170) the at least one segment of the user input using synthetic information derived from the sensitive information, with the synthetic information derived from the sensitive information being less sensitive according to the sensitivity criterion, and providing (180) the user input to the remote computer system.

Another example (e.g., example 22) relates to a previous example (e.g., example 21) or to any other example, further comprising that the user input comprises written textual input, with the written textual input being subdivided into discrete segments, with the method comprising generating tokens (130) representing the written textual input of the respective segments.

Another example (e.g., example 23) relates to a previous example (e.g., one of the examples 21 or 22) or to any other example, further comprising that replacing the at least one segment of the user input comprises generating (171) written text based on the synthetic information derived from the sensitive information

Another example (e.g., example 24) relates to a previous example (e.g., one of the examples 21 to 23) or to any other example, further comprising that the user input comprises spoken textual input, with the spoken textual input being subdivided into discrete segments, with the method comprising generating tokens (130) representing the spoken textual input of the respective segments.

Another example (e.g., example 25) relates to a previous example (e.g., one of the examples 23 or 24) or to any other example, further comprising that replacing the at least one segment of the user input comprises generating (172) spoken text based on the synthetic information derived from the sensitive information.

Another example (e.g., example 26) relates to a previous example (e.g., one of the examples 21 to 25) or to any other example, further comprising that the user input comprises visual input, with replacing the at least one segment of the user input comprising generating (173) a visual replacement for the at least one segment containing sensitive information based on the synthetic information derived from the sensitive information.

Another example (e.g., example 27) relates to a previous example (e.g., example 26) or to any other example, further comprising that the visual input is image data of a camera.

Another example (e.g., example 28) relates to a previous example (e.g., one of the examples 26 or 27) or to any other example, further comprising that the visual input is image data of a presentation or screenshare during an online meeting.

Another example (e.g., example 29) relates to a previous example (e.g., one of the examples 26 to 28) or to any other example, further comprising that the visual input is subdivided into segments, with the method comprising generating tokens (130) representing written textual input or graphical input contained in the respective segments of the visual input.

Another example (e.g., example 30) relates to a previous example (e.g., one of the examples 21 to 29) or to any other example, further comprising that the synthetic information is derived from the sensitive information using a language model.

Another example (e.g., example 31) relates to a previous example (e.g., one of the examples 21 to 30) or to any other example, further comprising that the method comprises determining (150) whether the at least one segment that contains sensitive information is deemed essential information in the context of the user input provided to the remote computer system, and preserving the at least one segment of the user input if the at least one segment is deemed essential.

Another example (e.g., example 32) relates to a previous example (e.g., one of the examples 21 to 31) or to any other example, further comprising that the method comprises determining (160) whether the at least one segment of the user input can be replaced with information derived from the sensitive information, and removing the at least one segment of the user input or replacing the at least one segment of the user input with a pre-defined marker if the determination is negative.

Another example (e.g., example 33) relates to a previous example (e.g., one of the examples 21 to 32) or to any other example, further comprising that processing the plurality of discrete segments to determine at least one segment that contains sensitive information comprises comparing (145) the plurality of discrete segments to embeddings of one or more sensitive topics.

Another example (e.g., example 34) relates to a previous example (e.g., example 33) or to any other example, further comprising that at least a subset of the one or more sensitive topics are selected by a user from a plurality of sensitive topics.

Another example (e.g., example 35) relates to a previous example (e.g., one of the examples 33 or 34) or to any other example, further comprising that at least a subset of the one or more sensitive topics are topics manually defined by a user.

Another example (e.g., example 36) relates to a previous example (e.g., one of the examples 33 to 35) or to any other example, further comprising that the method comprises providing (105) a user interface for selecting or specifying sensitive topics.

Another example (e.g., example 37) relates to a previous example (e.g., one of the examples 33 to 36) or to any other example, further comprising that the sensitivity criterion is based on a distance of the respective segments from the embeddings of the one or more sensitive topics in embedding space.

Another example (e.g., example 38) relates to a previous example (e.g., one of the examples 21 to 37) or to any other example, further comprising that the method comprises obtaining (190) a response from the remote computer system after providing the user input, and replacing (195) the synthetic information included in the response with the original sensitive information in the response of the remote computer system.

Another example (e.g., example 39) relates to a previous example (e.g., one of the examples 21 to 38) or to any other example, further comprising that at least the acts of subdividing the user input, processing the plurality of discrete segments to determine at least one segment that contains sensitive information and replacing the at least one segment of the user input are performed in a firmware layer of the computer system, with the user input being routed through the firmware layer.

Another example (e.g., example 40) relates to a previous example (e.g., example 39) or to any other example, further comprising that the respective functionality of the firmware layer is secured by a trusted execution environment of the computer system.

An example (e.g., example 41) relates to an apparatus (10) for a computer system (100), comprising interface circuitry (12), machine-readable instructions, and processor circuitry (14) to execute the machine-readable instructions to obtain user input intended for a remote computer system, subdivide the user input into a plurality of discrete segments, process the plurality of discrete segments to determine at least one segment that contains sensitive information according to a sensitivity criterion, replace the at least one segment of the user input using synthetic information derived from the sensitive information, with the synthetic information derived from the sensitive information being less sensitive according to the sensitivity criterion, and provide the user input to the remote computer system.

Another example (e.g., example 42) relates to a previous example (e.g., example 41) or to any other example, further comprising that the user input comprises written textual input, with the written textual input being subdivided into discrete segments, with the processor circuitry to execute the machine-readable instructions to generate tokens representing the written textual input of the respective segments.

Another example (e.g., example 43) relates to a previous example (e.g., one of the examples 41 or 42) or to any other example, further comprising that replacing the at least one segment of the user input comprises generating written text based on the synthetic information derived from the sensitive information

Another example (e.g., example 44) relates to a previous example (e.g., one of the examples 41 to 43) or to any other example, further comprising that the user input comprises spoken textual input, with the spoken textual input being subdivided into discrete segments, with the processor circuitry to execute the machine-readable instructions to generate tokens representing the spoken textual input of the respective segments.

Another example (e.g., example 45) relates to a previous example (e.g., one of the examples 43 or 44) or to any other example, further comprising that replacing the at least one segment of the user input comprises generating spoken text based on the synthetic information derived from the sensitive information.

Another example (e.g., example 46) relates to a previous example (e.g., one of the examples 41 to 45) or to any other example, further comprising that the user input comprises visual input, with replacing the at least one segment of the user input comprising generating a visual replacement for the at least one segment containing sensitive information based on the synthetic information derived from the sensitive information.

Another example (e.g., example 47) relates to a previous example (e.g., example 46) or to any other example, further comprising that the visual input is image data of a camera.

Another example (e.g., example 48) relates to a previous example (e.g., one of the examples 46 or 47) or to any other example, further comprising that the visual input is image data of a presentation or screenshare during an online meeting.

Another example (e.g., example 49) relates to a previous example (e.g., one of the examples 46 to 48) or to any other example, further comprising that the visual input is subdivided into segments, with the processor circuitry to execute the machine-readable instructions to generate tokens representing written textual input or graphical input contained in the respective segments of the visual input.

Another example (e.g., example 50) relates to a previous example (e.g., one of the examples 41 to 49) or to any other example, further comprising that the synthetic information is derived from the sensitive information using a language model.

Another example (e.g., example 51) relates to a previous example (e.g., one of the examples 41 to 50) or to any other example, further comprising that the processor circuitry is to execute the machine-readable instructions to determine whether the at least one segment that contains sensitive information is deemed essential information in the context of the user input provided to the remote computer system, and preserve the at least one segment of the user input if the at least one segment is deemed essential.

Another example (e.g., example 52) relates to a previous example (e.g., one of the examples 41 to 51) or to any other example, further comprising that the processor circuitry is to execute the machine-readable instructions to determine whether the at least one segment of the user input can be replaced with information derived from the sensitive information, and remove the at least one segment of the user input or replacing the at least one segment of the user input with a pre-defined marker if the determination is negative.

Another example (e.g., example 53) relates to a previous example (e.g., one of the examples 41 to 52) or to any other example, further comprising that processing the plurality of discrete segments to determine at least one segment that contains sensitive information comprises comparing the plurality of discrete segments to embeddings of one or more sensitive topics.

Another example (e.g., example 54) relates to a previous example (e.g., example 53) or to any other example, further comprising that at least a subset of the one or more sensitive topics are selected by a user from a plurality of sensitive topics.

Another example (e.g., example 55) relates to a previous example (e.g., one of the examples 53 or 54) or to any other example, further comprising that at least a subset of the one or more sensitive topics are topics manually defined by a user.

Another example (e.g., example 56) relates to a previous example (e.g., one of the examples 53 to 55) or to any other example, further comprising that the processor circuitry is to execute the machine-readable instructions to provide a user interface for selecting or specifying sensitive topics.

Another example (e.g., example 57) relates to a previous example (e.g., one of the examples 53 to 56) or to any other example, further comprising that the sensitivity criterion is based on a distance of the respective segments from the embeddings of the one or more sensitive topics in embedding space.

Another example (e.g., example 58) relates to a previous example (e.g., one of the examples 41 to 57) or to any other example, further comprising that the processor circuitry is to execute the machine-readable instructions to obtain a response from the remote computer system after providing the user input, and replace the synthetic information included in the response with the original sensitive information in the response of the remote computer system.

Another example (e.g., example 59) relates to a previous example (e.g., one of the examples 41 to 58) or to any other example, further comprising that the processor circuitry is at least partially to execute the machine-readable instructions in a firmware layer of the computer system, with the user input being routed through the firmware layer.

Another example (e.g., example 60) relates to a previous example (e.g., example 59) or to any other example, further comprising that the respective functionality of the firmware layer is secured by a trusted execution environment of the computer system.

An example (e.g., example 61) relates to a device (10) for a computer system (100), the device comprising means for communicating (12), and means for processing (14) for obtaining user input intended for a remote computer system, subdividing the user input into a plurality of discrete segments, processing the plurality of discrete segments to determine at least one segment that contains sensitive information according to a sensitivity criterion, replacing the at least one segment of the user input using synthetic information derived from the sensitive information, with the synthetic information derived from the sensitive information being less sensitive according to the sensitivity criterion, and providing the user input to the remote computer system.

Another example (e.g., example 62) relates to a previous example (e.g., example 61) or to any other example, further comprising that the user input comprises written textual input, with the written textual input being subdivided into discrete segments, with the means for processing being configured to generate tokens representing the written textual input of the respective segments.

Another example (e.g., example 63) relates to a previous example (e.g., one of the examples 61 or 62) or to any other example, further comprising that replacing the at least one segment of the user input comprises generating written text based on the synthetic information derived from the sensitive information

Another example (e.g., example 64) relates to a previous example (e.g., one of the examples 61 to 63) or to any other example, further comprising that the user input comprises spoken textual input, with the spoken textual input being subdivided into discrete segments, with the means for processing being configured to generate tokens representing the spoken textual input of the respective segments.

Another example (e.g., example 65) relates to a previous example (e.g., one of the examples 63 or 64) or to any other example, further comprising that replacing the at least one segment of the user input comprises generating spoken text based on the synthetic information derived from the sensitive information.

Another example (e.g., example 66) relates to a previous example (e.g., one of the examples 61 to 65) or to any other example, further comprising that the user input comprises visual input, with replacing the at least one segment of the user input comprising generating a visual replacement for the at least one segment containing sensitive information based on the synthetic information derived from the sensitive information.

Another example (e.g., example 67) relates to a previous example (e.g., example 66) or to any other example, further comprising that the visual input is image data of a camera.

Another example (e.g., example 68) relates to a previous example (e.g., one of the examples 66 or 67) or to any other example, further comprising that the visual input is image data of a presentation or screenshare during an online meeting.

Another example (e.g., example 69) relates to a previous example (e.g., one of the examples 66 to 68) or to any other example, further comprising that the visual input is subdivided into segments, with the means for processing being configured to generate tokens representing written textual input or graphical input contained in the respective segments of the visual input.

Another example (e.g., example 70) relates to a previous example (e.g., one of the examples 61 to 69) or to any other example, further comprising that the synthetic information is derived from the sensitive information using a language model.

Another example (e.g., example 71) relates to a previous example (e.g., one of the examples 61 to 70) or to any other example, further comprising that the means for processing is configured to determine whether the at least one segment that contains sensitive information is deemed essential information in the context of the user input provided to the remote computer system, and preserve the at least one segment of the user input if the at least one segment is deemed essential.

Another example (e.g., example 72) relates to a previous example (e.g., one of the examples 61 to 71) or to any other example, further comprising that the means for processing is configured to determine whether the at least one segment of the user input can be replaced with information derived from the sensitive information, and remove the at least one segment of the user input or replacing the at least one segment of the user input with a pre-defined marker if the determination is negative.

Another example (e.g., example 73) relates to a previous example (e.g., one of the examples 61 to 72) or to any other example, further comprising that processing the plurality of discrete segments to determine at least one segment that contains sensitive information comprises comparing the plurality of discrete segments to embeddings of one or more sensitive topics.

Another example (e.g., example 74) relates to a previous example (e.g., example 73) or to any other example, further comprising that at least a subset of the one or more sensitive topics are selected by a user from a plurality of sensitive topics.

Another example (e.g., example 75) relates to a previous example (e.g., one of the examples 73 or 74) or to any other example, further comprising that at least a subset of the one or more sensitive topics are topics manually defined by a user.

Another example (e.g., example 76) relates to a previous example (e.g., one of the examples 73 to 75) or to any other example, further comprising that the means for processing is configured to provide a user interface for selecting or specifying sensitive topics.

Another example (e.g., example 77) relates to a previous example (e.g., one of the examples 73 to 76) or to any other example, further comprising that the sensitivity criterion is based on a distance of the respective segments from the embeddings of the one or more sensitive topics in embedding space.

Another example (e.g., example 78) relates to a previous example (e.g., one of the examples 61 to 77) or to any other example, further comprising that the means for processing is configured to obtain a response from the remote computer system after providing the user input, and replace the synthetic information included in the response with the original sensitive information in the response of the remote computer system.

Another example (e.g., example 79) relates to a previous example (e.g., one of the examples 61 to 78) or to any other example, further comprising that the means for processing is at least partially configured to execute the machine-readable instructions in a firmware layer of the computer system, with the user input being routed through the firmware layer.

Another example (e.g., example 80) relates to a previous example (e.g., example 79) or to any other example, further comprising that the respective functionality of the firmware layer is secured by a trusted execution environment of the computer system.

Another example (e.g., example 81) relates to a computer system comprising the apparatus according to one of the examples 41 to 60 or the device according to one of the examples 61 to 80.

Another example (e.g., example 82) relates to a computer system being configured to perform the method according to one of the examples 21 to 40.

Another example (e.g., example 83) relates to a computer program having a program code for performing the method of one of the examples 21 to 40, when the computer program is executed on a computer, a processor, or a programmable hardware component.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processing circuitries, cause the one or more processing circuitries to perform a method for a computer system, comprising:
obtaining user input intended for a remote computer system;
subdividing the user input into a plurality of discrete segments;
processing the plurality of discrete segments to determine at least one segment that contains sensitive information according to a sensitivity criterion;
replacing the at least one segment of the user input using synthetic information derived from the sensitive information, with the synthetic information derived from the sensitive information being less sensitive according to the sensitivity criterion; and
providing the user input to the remote computer system.

2. The non-transitory computer-readable medium according to claim 1, wherein the user input comprises written textual input, with the written textual input being subdivided into discrete segments, with the method comprising generating tokens representing the written textual input of the respective segments.

3. The non-transitory computer-readable medium according to claim 1, wherein replacing the at least one segment of the user input comprises generating written text based on the synthetic information derived from the sensitive information

4. The non-transitory computer-readable medium according to claim 1, wherein the user input comprises spoken textual input, with the spoken textual input being subdivided into discrete segments, with the method comprising generating tokens representing the spoken textual input of the respective segments.

5. The non-transitory computer-readable medium according to claim 4, wherein replacing the at least one segment of the user input comprises generating spoken text based on the synthetic information derived from the sensitive information.

6. The non-transitory computer-readable medium according to claim 1, wherein the user input comprises visual input, with replacing the at least one segment of the user input comprising generating a visual replacement for the at least one segment containing sensitive information based on the synthetic information derived from the sensitive information.

7. The non-transitory computer-readable medium according to claim 6, wherein the visual input is image data of a camera or image data of a presentation or screenshare during an online meeting.

8. The non-transitory computer-readable medium according to claim 6, wherein the visual input is subdivided into segments, with the method comprising generating tokens representing written textual input or graphical input contained in the respective segments of the visual input.

9. The non-transitory computer-readable medium according to claim 1, wherein the synthetic information is derived from the sensitive information using a language model.

10. The non-transitory computer-readable medium according to claim 1, wherein the method comprises determining whether the at least one segment that contains sensitive information is deemed essential information in the context of the user input provided to the remote computer system, and preserving the at least one segment of the user input if the at least one segment is deemed essential.

11. The non-transitory computer-readable medium according to claim 1, wherein the method comprises determining whether the at least one segment of the user input can be replaced with information derived from the sensitive information, and removing the at least one segment of the user input or replacing the at least one segment of the user input with a pre-defined marker if the determination is negative.

12. The non-transitory computer-readable medium according to claim 1, wherein processing the plurality of discrete segments to determine at least one segment that contains sensitive information comprises comparing the plurality of discrete segments to embeddings of one or more sensitive topics.

13. The non-transitory computer-readable medium according to claim 12, wherein at least a subset of the one or more sensitive topics are selected by a user from a plurality of sensitive topics or manually defined by a user.

14. The non-transitory computer-readable medium according to claim 12, wherein the method comprises providing a user interface for selecting or specifying sensitive topics.

15. The non-transitory computer-readable medium according to claim 12, wherein the sensitivity criterion is based on a distance of the respective segments from the embeddings of the one or more sensitive topics in embedding space.

16. The non-transitory computer-readable medium according to claim 1, wherein the method comprises obtaining a response from the remote computer system after providing the user input, and replacing the synthetic information included in the response with the original sensitive information in the response of the remote computer system.

17. A method for a computer system, comprising:
obtaining user input intended for a remote computer system;
subdividing the user input into a plurality of discrete segments;
processing the plurality of discrete segments to determine at least one segment that contains sensitive information according to a sensitivity criterion;
replacing the at least one segment of the user input using synthetic information derived from the sensitive information, with the synthetic information derived from the sensitive information being less sensitive according to the sensitivity criterion; and
providing the user input to the remote computer system.

18. The method according to claim 17, wherein at least the acts of subdividing the user input, processing the plurality of discrete segments to determine at least one segment that contains sensitive information and replacing the at least one segment of the user input are performed in a firmware layer of the computer system, with the user input being routed through the firmware layer.

19. An apparatus for a computer system, comprising interface circuitry, machine-readable instructions, and processor circuitry to execute the machine-readable instructions to:
obtain user input intended for a remote computer system;
subdivide the user input into a plurality of discrete segments;
process the plurality of discrete segments to determine at least one segment that contains sensitive information according to a sensitivity criterion;
replace the at least one segment of the user input using synthetic information derived from the sensitive information, with the synthetic information derived from the sensitive information being less sensitive according to the sensitivity criterion; and
provide the user input to the remote computer system.

20. The apparatus according to claim 19, wherein the user input comprises written textual input, with the written textual input being subdivided into discrete segments, with the processor circuitry to execute the machine-readable instructions to generate tokens representing the written textual input of the respective segments.
